(19) United States
(12) Patent Application Publication
(10) Pub. No.: US 2010/0001627 A1
(43) Pub. Date: Jan. 7, 2010

(54) Incandescent Bulb and Method for the Production Thereof

(75) Inventors: Peter Althof, Wipperfurth (DE); Helmut Berger, Lindlar (DE); Hans Liermann, Kuerten (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munchen (DE)

(21) Appl. No.: 12/438,257

(22) PCT Filed: Aug. 29, 2006
(86) PCT No.: PCT/EP06/65760

§ 371 Date: Feb. 20, 2009

(51) Int. Cl. H01K 1/14; H01J 9/00

(52) U.S. Cl. 313/315; 445/27

(57) ABSTRACT

An incandescent lamp including a lamp vessel with a pinch seal at one end, at least one incandescent filament being accommodated in the interior of said lamp vessel, the incandescent filament being fixed in position in the lamp vessel by at least one electrically insulating holding element provided with filament holders wherein the holding elements are held in the lamp vessel by sections of said lamp vessel being subjected to hot shaping.

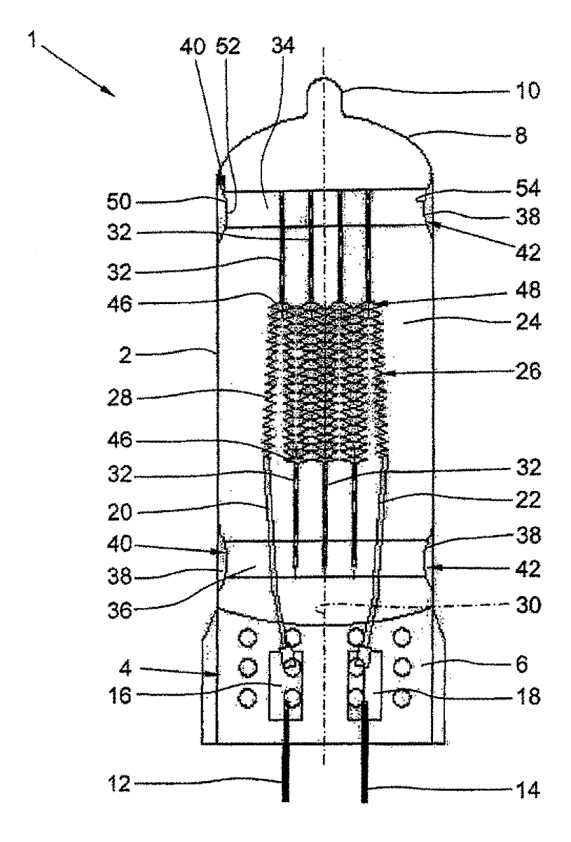

### TECHNICAL FIELD

The invention relates to an incandescent lamp, in particular to an incandescent halogen lamp intended for the medium-voltage or high-voltage range, with a lamp vessel with a pinch seal at one end, at least one incandescent filament being accommodated in the interior of said lamp vessel, the incandescent filament being fixed in position in the lamp vessel by at least one electrically insulating holding element provided with filament holders.

### PRIOR ART

Such an incandescent lamp and a method for the production thereof are known, for example, from EP 0 751 550 A1. This conventional incandescent lamp in the form of an incandescent halogen lamp has an incandescent filament, which is fixed as a planar luminous body within a lamp vessel. A frame-like rack, which substantially comprises two quartz glass bars which are connected to one another parallel and spaced apart from one another by two rack wires fused into the base of the lamp and are held in the lamp vessel, is used for holding the incandescent filaments. Hook-shaped filament holders, which extend in the direction of the incandescent filament, are fixed in the quartz glass bars. The quartz glass bars and the rack wires form a rectangular frame, in which the incandescent filament is clamped by means of the filament holders in such a way that it forms a planar filament array, the two rack wires furthermore also acting as power supply lines for the incandescent filament.

One disadvantage with such lamps is the fact that the introduction and fastening of the quartz glass bars by means of the rack wires requires a high degree of complexity in terms of manufacture and often does not meet the stringent requirements for the positioning of the filament array in the lamp vessel.

### DESCRIPTION OF THE INVENTION

The invention is based on the object of providing an incandescent lamp and a method for the production thereof, in which improved filament positioning in the lamp vessel given a minimum degree of complexity in terms of apparatus is made possible in comparison with conventional solutions.

This object is achieved by an incandescent lamp with a lamp vessel with a pinch seal at one end, at least one incandescent filament being accommodated in the interior of said lamp vessel, the incandescent filament being fixed in position in the lamp vessel by at least one electrically insulating holding element provided with filament holders, the holding elements being fixed in the lamp vessel by sections of said lamp vessel being subjected to hot shaping. This object is furthermore achieved by a method for the production of an incandescent lamp in which the incandescent filament is suspended in the filament holders of the holding elements and the incandescent filament which is suspended in the filament holders of the holding elements is positioned, prestressed, in the lamp vessel, the holding elements being fixed in the lamp vessel by hot-shaping of the lamp vessel, with the result that the prestress of the incandescent filament is maintained. Particularly advantageous embodiments of the invention are described in the dependent claims.

In the solution according to the invention, it is possible to dispense with rack wires for positioning and fixing the holding elements in the lamp vessel as a result of the holding elements which are fixed in the lamp vessel by hot-shaping thereof, in contrast to the prior art, with the result that improved filament positioning in the lamp vessel given a minimum degree of complexity in terms of manufacture is made possible. As a result of the even more precise positioning of the filament array in this case, the light center of the incandescent filament can be adjusted more precisely, with the result that the light quality of the lamp is substantially improved. Owing to the holding elements which are fixed in the lamp vessel by hot-shaping thereof, automation of the lamp manufacture is furthermore possible, with the result that the production costs are further reduced. Such incandescent lamps are used, for example, as studio, spotlight or projection lamps and are characterized by a high thermal and mechanical strength, with the result that a long life of the incandescent lamp is achieved.

In accordance with a particularly preferred exemplary embodiment of the invention, two holding elements are arranged spaced apart parallel to one another in the lamp vessel, said holding elements extending substantially perpendicular to a lamp longitudinal axis.

It has proven to be particularly advantageous if the holding elements are fixed in position in the lamp vessel by means of pinch-sealing knobs. In this case, end sections of the holding elements each are preferably embedded, at least over sections, in one of the pinch-sealing knobs and are thus held in the lamp vessel. The pinch-sealing knobs are formed by wall regions of the lamp vessel which are deformed inwards, towards the holding elements, i.e. the wall of the lamp vessel is deformed inwards in the region of the pinch-sealing knobs, with the result that the holding elements are each clamped in between the two end faces of the pinch-sealing knobs and are therefore fixed in position.

The holding elements are preferably in the form of quartz glass bars provided with hook-shaped filament holders. In a preferred embodiment according to the invention, the incandescent filament has a large number of filament sections, connecting regions of the filament sections each being held in the hook-shaped filament holders.

The incandescent filament is preferably suspended between the holding elements in the filament holders in such a way that a flat luminous body with a substantially planar filament array is formed.

In the method according to the invention, it is preferred to introduce the pinch-sealing knobs into the lamp vessel approximately at the same time, for example by means of four dies, in such a way that the two quartz glass bars are held at the ends in each case via one pinch-sealing knob.

### BRIEF DESCRIPTION OF THE DRAWING

The invention will be explained in more detail below with reference to a preferred exemplary embodiment. The single FIGURE shows a schematic illustration of an incandescent lamp according to the invention in the form of an incandescent halogen lamp for the high-voltage range, as is used, for example, in studio lighting.

### PREFERRED EMBODIMENT OF THE INVENTION

The figure shows a side view of an incandescent lamp 1 according to the invention in the form of an incandescent halogen lamp with an approximately cylindrical lamp vessel 2 consisting of quartz glass, with a base 6 being formed on the lower (in the figure) end section of said lamp vessel by a pinch seal 4, via which base 6 the incandescent halogen lamp 1 can be inserted into a lampholder (not illustrated). That end section of the lamp vessel 2 which is remote from the base 6 is formed by a dome 8, which has an exhaust tube tip 10, which is arranged diametrically with respect to the pinch seal 4 and onto which an exhaust tube has been attached during production of the lamp 1. Two outer power supply lines 12, 14 protrude out of the pinch seal 4 and are connected to an inner power supply line 20, 22 in each case via molybdenum foil 16, 18 embedded in the pinch seal 4. The inner power supply lines 20, 22 extend into an interior 24 of the lamp vessel 2 and are each connected to one end of an incandescent filament 26 arranged within the lamp vessel 2. Said incandescent filament 26 has eight series-connected light-emitting filament sections 28, which are aligned substantially parallel to a lamp longitudinal axis 30. In order to hold the incandescent filament 26 in the lamp vessel 2, two electrically insulating holding elements 34, 36 provided with filament holders 32 are arranged parallel and spaced apart in the lamp vessel 2 and extend substantially perpendicular to the lamp longitudinal axis 30. The two holding elements 34, 36 are fixed in position in the lamp vessel 2 by hot-shaping thereof over sections. For this purpose, it has proven to be particularly advantageous to fix the holding elements 34, 36 in the lamp vessel 2 by means of pinch-sealing knobs 38, which have a substantially circular cross section, end sections 40, 42 of the holding elements 34, 36 each being embedded in one of the pinch-sealing knobs 38. In accordance with the exemplary embodiment, the two holding elements 34, 36 are each in the form of quartz glass bars which are provided with hook-shaped filament holders 32 and are fixed at a defined distance from one another in the lamp vessel 2 by means of the pinch-sealing knobs 38. The filament sections 28 of the incandescent filament 26 are connected via connecting regions 46, which are each held in the filament holders 32. Four filament holders 32 are fused into the upper quartz glass bar 34 and three filament holders 32 are fused into the lower quartz glass bar 36, said filament holders 32 each extending approximately parallel to the lamp longitudinal axis 30 and having an approximately hook-shaped end section 48 for accommodating the connecting regions 46 of the incandescent filament 26 on the incandescent filament side. Furthermore, the two inner power supply lines 20, 22 are fused into the lower quartz glass bar 36. The incandescent filament 26 is suspended in the filament holders 32 between the quartz glass bars 34, 36 in such a way that a flat luminous body with a substantially planar filament array is formed and the incandescent filament 26 is mechanically prestressed. The inner power supply lines 20, 22 and the filament holders 32 preferably comprise molybdenum wire. The incandescent filament 26 is manufactured from tungsten.

In a method according to the invention for the production of the incandescent lamp 1, the incandescent filament 26 is suspended in the filament holders 32 of the quartz glass bars 34, 36 in a first working step. The quartz glass bars 34, 36, including the incandescent filament 26 suspended in the filament holders 32 and the power supply lines 12, 14, 20, 22 and the molybdenum foils 16, 18, are inserted into the lamp vessel 2, which is open at one end, after the flushing annealing process and the incandescent filament 26 is prestressed over the distance between the quartz glass bars 34, 36, the free ends of the outer power supply lines 12, 14 protruding out of the open end of the lamp vessel 2. If the incandescent filament 26 is located in the correct position, the lamp vessel 2 is heated externally in the region of the quartz glass bars 34, 36. Once the softening temperature of the quartz glass has been reached, four dies at the same time press the quartz glass against the quartz glass bars 34, 36 in such a way that said quartz glass bars 34, 36 are fixed at the same time in the lamp vessel 2. In this case, the four pinch-sealing knobs 38, which extend parallel to the plane of the drawing in the illustration, are formed on the lamp vessel 2. These pinch-sealing knobs 38, which are arranged diametrically with respect to one another in pairs, are formed by wall regions 50 of the lamp vessel 2 which are deformed inwards, towards the quartz glass bars 34, 36, i.e. the wall of said lamp vessel is deformed inwards in the region of the pinch-sealing knobs 38, with the result that the quartz glass bars 34, 36 are each clamped between the two end faces 52, 54, are encompassed over sections and are thus fixed in position. Then, the quartz glass of the lamp vessel 2 is softened in the region of the molybdenum foils 16, 18 by means of heating and pressed against said molybdenum foils by means of pinching jaws and the open end is sealed in a gas-tight manner. The lamp vessel 2 is evacuated, flushed and filled with a filling gas containing halogens via the exhaust tube in a known manner. Finally, the exhaust tube is fuse-sealed off.

The invention discloses an incandescent lamp 1, in particular an incandescent halogen lamp intended for the medium-voltage or high-voltage range, with a lamp vessel 2 with a pinch seal at one end, at least one incandescent filament 26 being accommodated in the interior 24 of said lamp vessel 2, the incandescent filament 26 being fixed in position in the lamp vessel 2 by at least one electrically insulating holding element 34, 36 provided with filament holders 32. According to the invention, the holding elements 34, 36 are fixed in position in the lamp vessel 2 by hot-shaping thereof. Furthermore, the invention discloses a method for the production of such an incandescent lamp 1.

1. An incandescent lamp including, lamp vessel with a pinch seal at one end, at least one incandescent filament being accommodated in the interior of said lamp vessel, the incandescent filament being fixed in position in the lamp vessel by at least one electrically insulating holding element provided with filament holders wherein the holding elements are held in the lamp vessel by sections of said lamp vessel being subjected to hot shaping.

2. The incandescent lamp as claimed in claim 1, the holding elements being fixed in position in the lamp vessel by means of pinch-sealing knobs.

3. The incandescent lamp as claimed in claim 2, end sections of the holding elements each being embedded, at least over sections, in one of the pinch-sealing knobs.

4. The incandescent lamp as claimed in claim 1, two holding elements being arranged spaced apart parallel to one another in the lamp vessel, said holding elements extending substantially perpendicular to a lamp longitudinal axis.

5. The incandescent lamp as claimed in claim 1, the holding element being a quartz glass bar.

6. The incandescent lamp as claimed in claim 1, the incandescent filament having a large number of filament sections, and connecting regions of the filament sections each being held in the filament holders.

7. The incandescent lamp as claimed in claim 1, the incandescent filament being arranged as a substantially planar filament array in the lamp vessel.

8. A method for the production of an incandescent lamp as claim 1, comprising the steps of:
a) suspending the incandescent filament in the filament holders of the holding elements;
b) positioning and prestressing the incandescent filament, which is suspended in the filament holders of the holding elements, in the lamp vessel, and
c) fixing the holding elements in the lamp vessel by hot-shaping of the lamp vessel over sections, with the result that the prestress and position of the incandescent filament is maintained.

9. The method as claimed in claim 8, two quartz glass bars being arranged as holding elements parallel and spaced apart from one another in the lamp vessel and being fixed in the lamp vessel by means of pinch-sealing knobs.

10. The method as claimed in claim 9, the pinch-sealing knobs being formed approximately at the same time.
